(19) United States
(12) Patent Application Publication
(10) Pub. No.: US 2007/0209208 A1
(43) Pub. Date: Sep. 13, 2007

(54) Adjustable blade utility knife

(76) Inventor: Michael Dunn-Rankin, Venice, FL (US)

Correspondence Address: FRANK A. LUKASIK, 1609 GOLDEN RIDGE DRIVE, THE VILLAGES, FL, 32162, US

(21) Appl. No.: 11/698,244

(22) Filed: Jan. 26, 2007

Related U.S. Application Data
(63) Continuation-in-part of application No. 11/373,692, filed on Mar. 13, 2006, now abandoned.

(51) Int. Cl. B26B 1/08

(52) U.S. Cl. 30/162

(57) ABSTRACT

An adjustable blade utility knife having a hollow body comprising two hinged body parts, a blade system for extending a four cutting edged blade, and a knurled knob mounted on opposite sides of the body for controlling the blade system with a finger of either hand of an operator. A second embodiment contains serrated edges. The blade may be manufactured using a refractory hard metal or cemented carbides. A blade storage area is formed inside the body.

### RELATED INVENTION

This is a Continuation-In-Part of Ser. No. 11/373,692, Filed Mar. 3, 2006.

The instant invention pertains generally to Utility knives, and more particularly to an adjustable blade utility knife in which the blade can be extended and returned so as to expose only the length of blade required and to a four cutting edge, double sided blade for said utility knife.

### BACKGROUND OF THE INVENTION

There exist numerous forms of utility knives each of which utilize a standard and ubiquitous blade. Many of these knives have adjustment mechanisms for extending the blade and then returning it to a safety position within the body of the knife. Most commonly, the body of the knife is a hollow chamber which is opened for blade replacement. Blade adjustment is generally made so as to allow for two or three extensions and often involves some form of “catch and release” system whereby a button or lever is depressed to permit the blade to move in or out and then released to engage a locking mechanism which holds the blade firmly.

Several prior art devices teach the construction of utility knives.

U.S. Pat. No. 5,875,551 to Huang discloses a knife which includes two housings having a front portion for engaging with blades. A rod is rotatably engaged in the rear portion of one of the housings. A cap is secured to one end of the rod, and a spring biases the cap to engage with the rear ends of the housings so as to secure the rear ends of the housings together.

U.S. Pat. No. 5,906,050 to Gilbert discloses a utility knife which is provided internally with a rectilinear guidance track for the cutting blade while the operating button for advancing and retracting the blade is guided in a curved slot.

U.S. Pat. No. 6,000,136 to Owens discloses a knife handle with a blade carrier having a planar support, parallel flanges and laterally projecting tabs for securing the blade in position on the carrier.

U.S. Pat. No. 6,966,113 to Fossella discloses a utility knife having a disposable blade cartridge in its handle that has front and rear blade compartments. Each compartment is sized to store a plurality of blades in side-by-side relation. Fresh blades are disposed in the front compartment and one end of each is advanced one at a time substantially out of the compartment into operative position by a carrier that is controlled by an actuator on the handle.

U.S. Pat. No. 6,968,622 to Ping discloses a utility knife having a handle and a blade holder which is pivotally mounted on the handle for movement from an unfolded position to a folded position. The handle has a space adapted to receive the blade holder when the blade holder is in the folded position.

The present invention seeks to improve on the prior art by providing a four cutting edged blade utility knife which permits the extension of the blade in incremental steps, such steps being infinitely variable, wherein the blade is held firmly against any longitudinal movement once the adjustment step has been completed.

### SUMMARY OF THE INVENTION

It is therefore an object of the invention to provide a utility knife with a hollow body comprised of two body pieces each longitudinally matched to the opposite half so as to form a body for containing the blade and mechanisms for extending the blade and locking means for keeping the body pieces in position.

It is a further object of the invention to provide a blade adjustment means which is simply activated by the user's thumb sliding a knurled pad to which the blade is attached.

A still further object of the invention is to provide a double sided blade having four cutting edges which effectively doubles the blade life.

A further object of the invention is to provide a means for deploying a double sided, four cutting edged, serrated blade.

### BRIEF DESCRIPTION OF THE DRAWINGS

FIGS. 1, 1a, 2 and 2a are opposite elevational views of the invention.

FIG. 2b is a side elevational view of the invention showing the maximum angle/depth of penetration.

FIG. 3 is a side elevational view of blades used in the utility knife of the invention.

FIGS. 4 and 5 are isometric views of the invention.

### DETAILED DESCRIPTION OF THE INVENTION

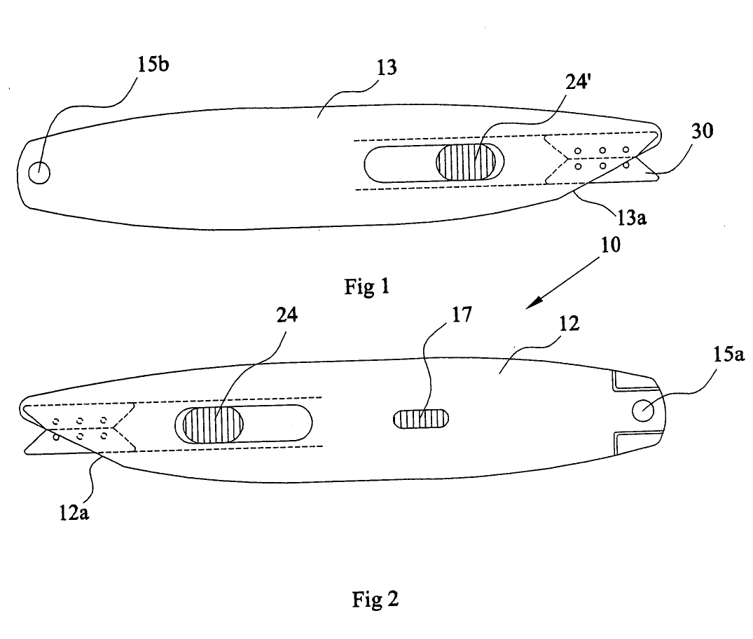

Referring to the drawings, the utility knife as described in the invention is designated overall by the numeral 10 and like numerals designate like and corresponding parts throughout the several views. Referring now to FIG. 1, blade 30 is shown partially in broken section. Blade adjustment knurled pad 24′ is positioned at the forwardmost end of its travel to extend the blade 30 beyond the knife body 10, sides 12 and 13, in a deployed position.

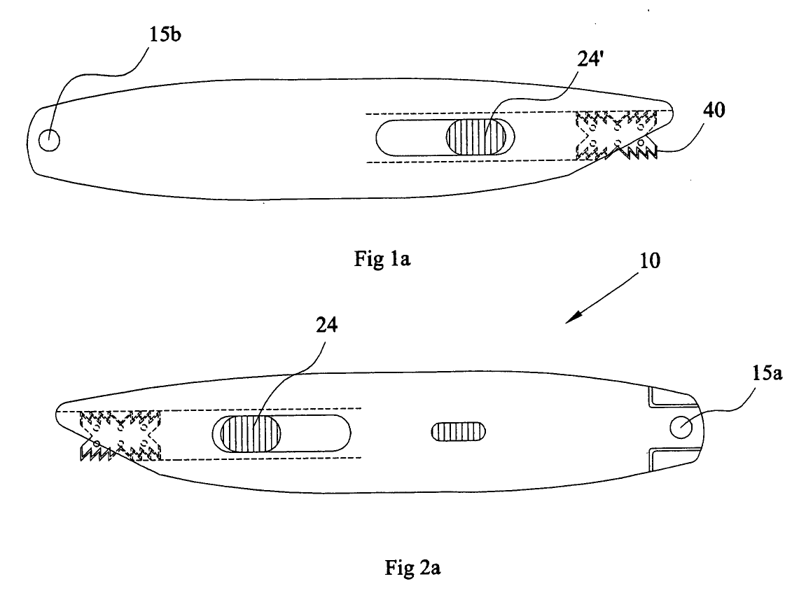

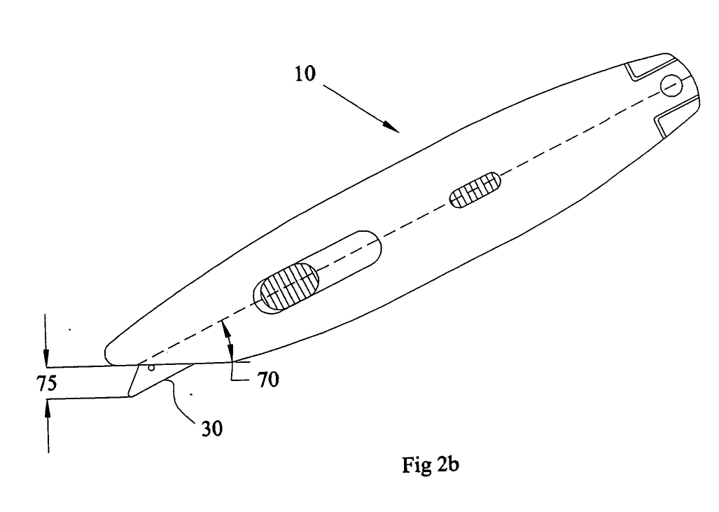

In FIG. 2, the utility knife 10 is shown in the obverse view and knurled pad 24 is positioned in a corresponding forwardmost position. Snap catch 17 is positioned within body side 12 of utility knife 10. FIGS. 1a and 2a illustrate a similar blade deployment with serrated blade 40. In both FIGS. 1 and 2, lower frontal edges 12a and 13a are undercut to provide maximum exposure of the cutting edges of blades 30 and 40.

In FIG. 2b, angle 70 positions the knife body 10 correctly to provide maximum exposure 75 of blade 30.

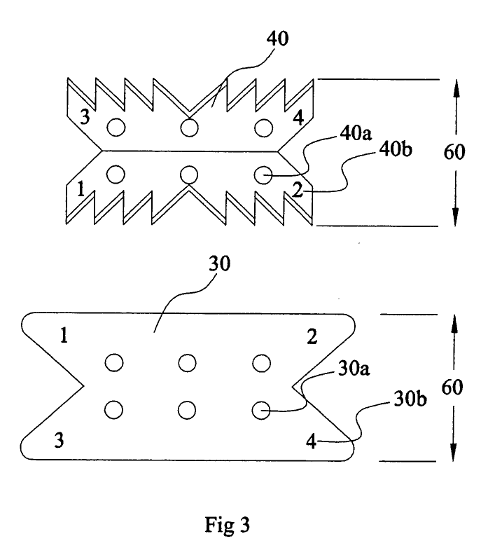

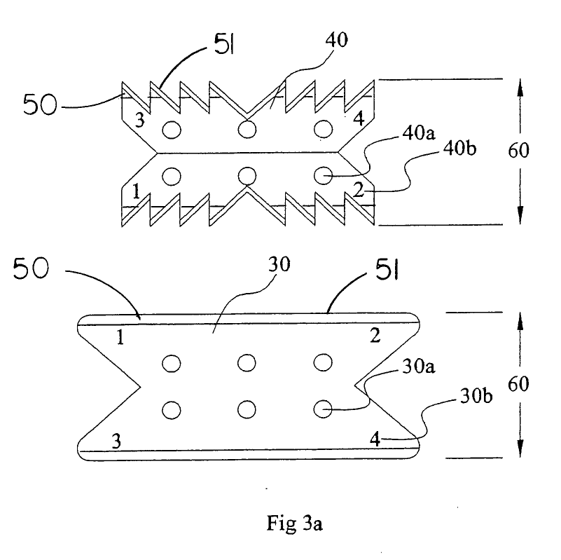

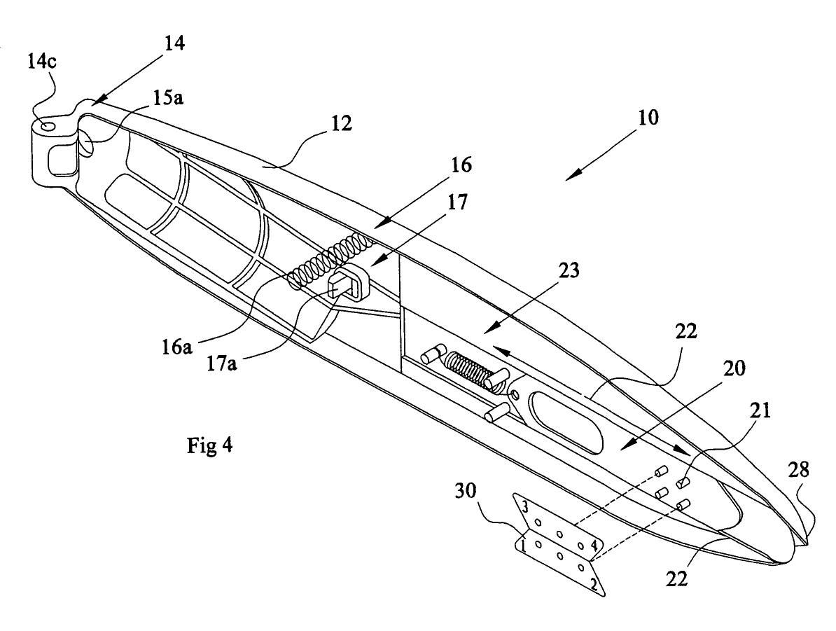

In FIG. 3, blades 30 and 40 have mounting holes 30a and 40a respectively, which are used to attach said blades to the blade carriage system 20 (FIG. 4). Both blades 30 and 40 share common height dimension 60. Numbers 30b and 40b are markers to identify which edge is or has been used. The blade will be rotated in sequence so that each cutting edge can be used. The blades 30 and 40 may be manufactured using Refractory Hard Metals (RHMs) and a group of materials more commonly known as cemented carbides to provide extra strength and durability. They consist of mixtures of one or more of the finely divided carbides of tungsten, titanium and vanadium embedded in a matrix of cobalt or nickel by sintering. One example of a tungsten carbide material is CERBIDE™.

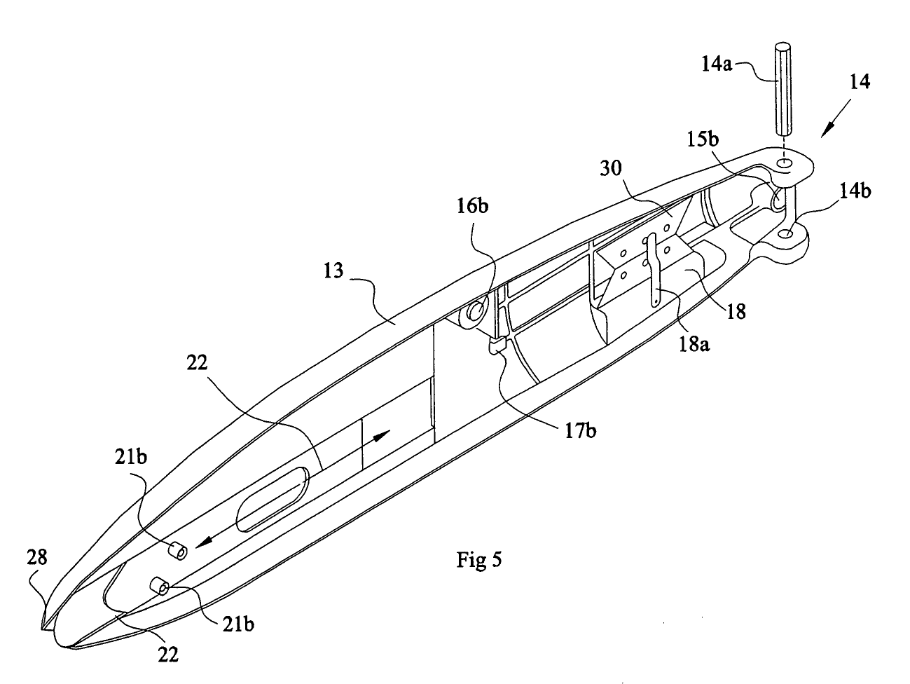

In FIGS. 4 and 5, rear hinge 14 contains pin holes 14b and 14c into which hinge pin 14a (FIG. 5) is offered up. Lanyard hole 15a in side 12 corresponds to lanyard hole 15b inside 13. Spring release mechanism 16 is comprised of spring 16a and spring pad 16b. Spring catch 17a engages tongue 17b. Blade carriage system 20 has blade fitting pins 21 onto which blade 30 (or 40) is mounted. Blades 30, and 40 are retained by said pins 21 and by tracks 22 formed in inside plates 25. Blade cover sides 12 and 13 protrude, as indicated by the numeral 23, (FIGS. 1-2a) to protect a user from the opposite cutting surface of the four top cutting edges (1 through 4) of blades 30 and 40. For example, when the cutting edge (3) is operative, cutting edge (1) is shielded by protrusion 23. Blade carriage system 20, connected with spring 27 to pin 26, is moved in the direction of arrows 28.

In FIG. 5, pin lugs 21b engage with pins 21 to sandwich blades 30 or 40 in place and transfer linear movement of blade carriage system 20 between side 12 and side 13 thus providing means for ambidextrous operation of said blade carriage system 20. Blade storage area 18 supports blades 30 and 40 which are held in place by spring clip 18a.

While a particular embodiment of the invention has been described, it is not intended that the invention be limited thereto, as it is intended that the invention be as broad in scope as the art will allow and that the specification be read likewise. It will therefor be appreciated by those skilled in the art that yet other modifications could be made to the provided invention without deviating from its spirit and scope as so claimed.

What is claimed is:

1. An adjustable blade utility knife in which a blade can be extended and returned so as to expose only the length of blade required, said utility knife comprising:
a hollow body having a first body side and a second body side, each side being longitudinally matched to the opposite half and pivotally attached together at a first end,
locking means for keeping said two body sides in position, said locking means having a snap catch positioned within said first body side in communication with a tongue positioned in said second body side, said first and second body sides having a protrusion formed at a first end for protecting a user from an opposite cutting surface not in use,
a blade mechanism slidably mounted within said hollow body for extending a blade, said blade mechanism having a blade carriage system and having blade fitting pins located on a first end and a return spring attached to a second end,
a blade having four cutting edges mounted on said blade fitting pins, said blade having identification numbers imprinted on each cutting edge, and,
a first knurled pad mounted on a first side and a second knurled pad mounted on a second side of said blade carriage system for controlling the extension of said blade carriage system with a finger of either hand of an operator.

3. An adjustable blade utility knife of claim 1 wherein a blade storage area is formed in said first body side and a spring clip being attached for holding spare blades in place.

4. An adjustable blade utility knife of claim 1 wherein said blade is made from refractory hard metals.

5. An adjustable blade utility knife of claim 1 wherein said blade is made of a material selected from a group consisting of refractory hard metals and cemented carbides.

6. An adjustable blade utility knife of claim 1 wherein said blade is made from a group of materials known as cemented carbides.

7. An adjustable blade utility knife of claim 1 wherein said blade is made with serrated cutting edges.
